(19) United States
(12) Patent Application Publication
(10) Pub. No.: US 2026/0300736 A1
(43) Pub. Date: Oct. 1, 2026

(54) METHODS AND SYSTEMS FOR MODEL TRAINING FOR LONG HORIZON PREDICTIONS USING TOKENIZED EVENTS

(71) Applicant: Shopify Inc., Ottawa (CA)

(72) Inventor: Alexandre Salle, Porto Alegre (BR)

(21) Appl. No.: 19/282,612

(22) Filed: Jul. 28, 2025

Related U.S. Application Data
(60) Provisional application No. 63/780,924, filed on Mar. 31, 2025.

(51) Int. Cl. G06N 3/084

(52) U.S. Cl. CPC G06N 3/084

(57) ABSTRACT

Methods and systems for training a machine learning (ML) model for predicting future token sets over different horizons are described. During pretraining, the present disclosure incorporates future token set prediction (FTSP) at various horizons as an additional pretraining objective for the ML model. The trained model predicts tokenized event sequences as future token sets over long future horizons, based on a historical sequence of events. The trained model may then be implemented to predict a likelihood of a target event occurring during a specified future horizon. The disclosed methods and systems may enable robust and efficient prediction of tokenized events extending further into the future than simply a next token while minimizing resource consumption associated with fine tuning computationally expensive foundation models.

### CROSS-REFERENCE TO RELATED APPLICATIONS

This application claims priority to and benefit of U.S. Provisional Patent Application No. 63/780,924 filed Mar. 31, 2025, entitled “METHODS AND SYSTEMS FOR MODEL TRAINING FOR LONG HORIZON PREDICTIONS USING TOKENIZED EVENTS”, the entire contents of which are incorporated by reference.

### FIELD

The present disclosure relates to machine learning, and, more particularly, to training machine learning models for predicting future token sets, and yet more particularly, to methods and systems for long horizon predictions using tokenized events.

### BACKGROUND

A foundation model is a type of deep machine learning (ML) model that has been pretrained on a large scale, generalist (e.g., broad) dataset and can be adapted to perform a wide range of specialized downstream tasks across many use cases.

A large language model (LLM), or another generative model, may be considered as a type of foundation model. For example, a LLM may be trained to learn billions of parameters in order to model how words relate to each other in a textual sequence. Inputs to an LLM may be referred to as prompts. A prompt is a natural language input that includes instructions to cause the LLM to generate a desired output, including natural language text or other generative output in various desired formats.

### SUMMARY

A method and system are provided for training a machine learning (ML) model to predict tokenized event sequences as future token sets over long horizons (e.g., step or time horizons), based on historical event sequences. During pretraining, the present disclosure incorporates future token set prediction (FTSP) at various time horizons as a pretraining objective for the ML model. The trained model may then be implemented to predict a likelihood of a target event occurring during a specified future time horizon, for a range of use cases. The disclosed methods and systems may enable robust and efficient prediction of tokenized events extending further into the future than simply a next token, while minimizing resource consumption associated with fine tuning computationally expensive foundation models.

Foundation models (such as large language models (LLMs), or other generative models) are deep learning models that have been pretrained on a large scale, generalist (or broad) dataset. In this way, foundation models provide a broad base level of knowledge and understanding of language and can be further trained to adapt the foundation model to a specific domain or task. For example, continued pretraining further expands a model's knowledge base with additional data, while fine-tuning adapts a model to perform a range of specialized tasks. Patterns and distributions contained in training data may be inherently identified and learned by a foundation model and used to generate new data that honors the inherent patterns. Foundation models are often characterized by their extensive number of parameters, which enable them to learn inherent correlations in unlabeled data. For this reason, (e.g., due to their size and complexity), training, implementing and maintaining foundation models can be computationally intensive.

Foundation models are widely known to be used for natural language processing or computer vision applications, however generative AI concepts may also be applied to event sequences. For example, by introducing events or actions as a modality in generative modelling, prediction problems can be represented as sequence transduction tasks. In this way, given a sequence of historical events, a foundation model can be configured to predict the next event.

Conventional foundation models operate using the principle of next token prediction (NTP). Using NTP, a model learns to predict the probability of the next token (P(token|prefix)) in a sequence, given a sequence of previous tokens (prefix), for example, one token at a time. If this is done autoregressively (e.g., where the predicted next token is fed back into the historical sequence), the foundation model can be used to predict a sequence of tokens. In the problem setting of estimating the probability of a token appearing in a future step or time horizon (e.g. next 100 steps or 100 days), rollouts may be used, for example, the trained model may be used to randomly sample next tokens to construct synthetic trajectories of potential future event sequences (e.g., similar to Monte Carlo Tree Search (MCTS)).

In some examples, rollouts may be used to address the above described challenge, for example, the trained model may be used to randomly sample next tokens to construct synthetic trajectories of potential future event sequences (e.g., similar to Monte Carlo Tree Search (MCTS)). The synthetic trajectories may then be used to estimate a probability of a particular event occurring among the synthetic trajectories. For long horizons, sampled trajectories can be hundreds to thousands of tokens long, which is computationally intensive. This cost is compounded by requiring many such trajectories to obtain a lower variance estimate, effectively making MCTS intractable.

Another approach to address the above-described challenge involves fine-tuning a foundation model as a classifier. In this method, given a historical sequence of events (a prefix), the task is to predict whether a specific target event will occur within a predefined future time horizon (e.g., within the next 7, 30, or 90 days). This is typically framed as a classification problem where a classification head is added to the foundation model. The model is then fine-tuned on a dataset of prefixes, each labeled with whether or not the target event occurred in the subsequent time horizon. However, this fine-tuning approach suffers from significant drawbacks in terms of scalability and computational cost. Because the fine-tuning process is task-specific, a distinct model must be trained for every unique combination of a target event and a future time horizon. This requirement to repeat the fine-tuning process for each prediction scenario consumes considerable computational resources. In some cases, the cost of fine-tuning can even be comparable to the initial pretraining, particularly when the fine-tuning dataset is large and similar to the pretraining data. Consequently, this method is inefficient and impractical for applications requiring predictions for multiple different events across various time horizons.

Advantageously, the disclosed technical solution enhances model pretraining by incorporating a future token set prediction (FTSP) objective alongside the traditional Next Token Prediction (NTP) task. This enhanced pretraining enables the model to predict the likelihood of any event of interest occurring within a given horizon, as long as the event is present in the training dataset. As a result, the disclosed solution provides a significant technical effect by reducing or eliminating the need for computationally expensive rollouts and repeated, task-specific fine-tuning.

A further technical benefit relates to the model's internal representations. The model continues to generate a per-token output embedding for each position in the input sequence. This output embedding serves a dual purpose: it is used to predict the single next token, consistent with conventional models, but it is also used by one or more prediction heads to predict the set of tokens likely to occur within a specified future time horizon. A significant technical benefit observed is that by training the model with the FTSP objective, the per-token embeddings themselves become more semantically rich. They are forced to capture more forward-looking information about the sequence's potential trajectory, making them substantially more useful for a variety of other downstream tasks beyond simple next-step prediction.

Advantageously, the technical solution employs horizon weights and token weights as parameters which can be set prior to initiating a pretraining process (e.g., to effectively reduce the size of the vocabulary) thereby providing a technical advantage in reducing the computational resources required for training. For example, setting a token weight to a value of zero effectively reduces the size of matrices, therefore requiring less memory, processing power, etc. and resulting in faster operation.

A technical benefit of the disclosed solution is that the trained foundation model can be used for both NTP or FTSP. In this regard, the model is generalizable using configuration settings, such that there is no need to train separate models, and a single training pass can prepare the model for both applications.

Examples of the disclosed future token set predictor provide the technical effect that event sequences can be predicted over different future horizons (e.g., step or time horizons) in a computationally efficient manner. The technical solution pretrains a foundation model to predict tokenized events over long time horizons, durations or steps, in a manner that is more computationally efficient than fine tuning the foundation model to perform the same task. For example, pretraining the model using four time horizons consumes significantly fewer computing resources (e.g., processing power, memory, computing time, etc.) than would be consumed using existing fine tuning approaches. For example, the model architecture includes a shared model trunk and a plurality of prediction heads, such that same forward pass of the shared model trunk is leveraged for every prediction head, making the additional compute cost associated with each prediction head insignificant. In contrast, fine-tuning the model to predict token sequences over four time horizons would require the model to be fine-tuned separately for each horizon (e.g., 4 times). In this way, the technical solution unifies the pretraining and finetuning processes, thereby eliminating the need for fine tuning, improving computational efficiency, providing greater flexibility and enhancing the model's overall utility.

The technical solution also provides a technical benefit of preprocessing future token sets on a CPU (rather than by the GPU at runtime) so they are always ready. In this regard, the GPU never has to wait for the future token sets, before performing the next step, thereby, allowing for more efficient use of the limiting resource in the system (e.g., GPU, or similar vector coprocessor).

In some examples, the present disclosure describes a computer-implemented method. The method includes a number of steps, including: training a machine learning (ML) model for predicting future token sets over different future horizons by: obtaining a training dataset comprising a set of historical event sequences; obtaining a set of configuration parameters associated with a plurality of prediction head layers of the ML model, each of the prediction head layers corresponding to a respective future horizon; and performing a plurality of training iterations for training the ML model, wherein each training iteration comprises: generating, based on the training dataset, a ML model output including a plurality of output feature tensors; determining a loss based on the plurality of output feature tensors and the set of historical event sequences; computing a gradient that minimizes the loss; and backpropagating, based on the computed gradient, the loss through the ML model to update values of weights of the ML model.

In an example of the preceding example aspect of the method, obtaining a set of trained model parameters, the model parameters having been generated according to the preceding example aspect of the method.

In an example of a preceding example aspect of the method, wherein the different future horizons represent different future time intervals, each future time interval having a start time and an end time in reference to a current time.

In an example of a preceding example aspect of the method, wherein the loss is a cross-entropy loss.

In an example of a preceding example aspect of the method, wherein the loss represents a sum of a next token prediction (NTP) loss and a future token set prediction (FTSP) loss.

In an example of a preceding example aspect of the method, wherein determining the loss comprises: determining one or more horizon losses, wherein each horizon loss corresponds to a respective future horizon, and wherein each future horizon is associated with a respective horizon weight value; and determining a FTSP loss as a sum of the one or more horizon losses.

In an example of the preceding example aspect of the method, wherein determining the FTSP loss comprises: determining a horizon loss as a sum of multiple token losses associated with multiple tokens in a future token prediction set, wherein each token is associated with a respective token weight value.

In an example of the preceding example aspect of the method, wherein dimensions of the output feature tensors are determined by dimensions of output sequence embeddings and a token vocabulary, the method further comprising: reducing the dimension of the token vocabulary by setting one or more token weight values equal to zero.

In an example of a preceding example aspect of the method, wherein the ML model is a foundation model.

In an example of a preceding example aspect of the method, the method further comprising: implementing the set of trained model parameters in an inference step to: generate a future token set corresponding to a respective future horizon; and predict whether an event of interest occurs in the future token set.

In some examples, the present disclosure describes a computer system including: a processing unit configured to execute computer-readable instructions to cause the system to: train a machine learning (ML) model for predicting future token sets over different future horizons by: obtaining a training dataset comprising a set of historical event sequences; obtaining a set of configuration parameters associated with a plurality of prediction head layers of the ML model, each of the prediction head layers corresponding to a respective future horizon; and performing a plurality of training iterations for training the ML model, wherein each training iteration comprises: generating, based on the training dataset, a ML model output including a plurality of output feature tensors; determining a loss based on the plurality of output feature tensors and the set of historical event sequences; computing a gradient that minimizes the loss; and backpropagating, based on the computed gradient, the loss through the ML model to update values of weights of the ML model.

In an example of the preceding example aspect of the system, wherein the different future horizons represent different future time intervals, each future time interval having a start time and an end time in reference to a current time.

In an example of a preceding example aspect of the system, wherein the loss is a cross-entropy loss.

In an example of a preceding example aspect of the system, wherein the loss represents a sum of a next token prediction (NTP) loss and a future token set prediction (FTSP) loss.

In an example of a preceding example aspect of the system, wherein in determining the loss, the processing unit is further configured to execute computer-readable instructions to cause the computer system to: determine one or more horizon losses, wherein each horizon loss corresponds to a respective future horizon, and wherein each future horizon is associated with a respective horizon weight value; and determine a FTSP loss as a sum of the one or more horizon losses.

In an example of the preceding example aspect of the system, wherein in determining the FTSP loss, the processing unit is further configured to execute computer-readable instructions to cause the computer system to: determine a horizon loss as a sum of multiple token losses associated with multiple tokens in a future token prediction set, wherein each token is associated with a respective token weight value.

In an example of the preceding example aspect of the system, wherein dimensions of the output feature tensors are determined by dimensions of output sequence embeddings and a token vocabulary, and the processing unit is further configured to execute computer-readable instructions to cause the computer system to: reduce the dimension of the token vocabulary by setting one or more token weight values equal to zero.

In an example of a preceding example aspect of the system, wherein the ML model is a foundation model.

In an example of a preceding example aspect of the system, wherein the processing unit is further configured to execute computer-readable instructions to cause the computer system to: obtain a set of trained model parameters corresponding to the trained ML model; and implement the set of trained model parameters in an inference step to: generate a future token set corresponding to a respective time horizon; and predict whether an event of interest occurs in the future token set.

In some examples, the present disclosure describes a non-transitory computer-readable medium storing instructions that, when executed by a processing unit of a computing system, cause the computing system to: train a machine learning (ML) model for predicting future token sets over different future horizons by: obtaining a training dataset comprising a set of historical event sequences; obtaining a set of configuration parameters associated with a plurality of prediction head layers of the ML model, each of the prediction head layers corresponding to a respective future horizon; and performing a plurality of training iterations for training the ML model, wherein each training iteration comprises: generating, based on the training dataset, a ML model output including a plurality of output feature tensors; determining a loss based on the plurality of output feature tensors and the set of historical event sequences; computing a gradient that minimizes the loss; and backpropagating, based on the computed gradient, the loss through the ML model to update values of weights of the ML model.

In some examples, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1 is a block diagram of a simplified transformer neural network, which may be used in examples of the present disclosure;

FIG. 2 is a block diagram of an example computing system, which may be used to implement examples of the present disclosure;

FIG. 3 is a simplified schematic diagram of an example event sequence, in accordance with examples of the present disclosure;

FIG. 4 is a simplified block diagram of an example architecture for a future token set predictor, in accordance with examples of the present disclosure;

FIG. 5 illustrates an example algorithm for computing a future token set, in accordance with examples of the present disclosure;

FIG. 6 is a flowchart of an example method for training the future token set predictor, in accordance with examples of the present disclosure; and

FIG. 7 is a flowchart of an example method for training the future token set predictor, in accordance with examples of the present disclosure.

Similar reference numerals may have been used in different figures to denote similar components.

### DETAILED DESCRIPTION

In various examples, the present disclosure describes methods and systems for training a future token set predictor. Examples of the disclosed solution may improve the performance of future token set prediction using a ML model trained in a computationally efficient manner, thereby reducing the use of computing resources (e.g., processing power, memory, computing time, etc.) associated with predicting event tokens over longer time horizons.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

Some concepts in ML-based language models are now discussed. It may be noted that, while the term “language model” has been commonly used to refer to a ML-based language model, there could exist non-ML language models.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pretrained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model or sequence model, including language models or sequence models based on other neural network architectures such as recurrent neural network (RNN)-based language models, state space models etc.

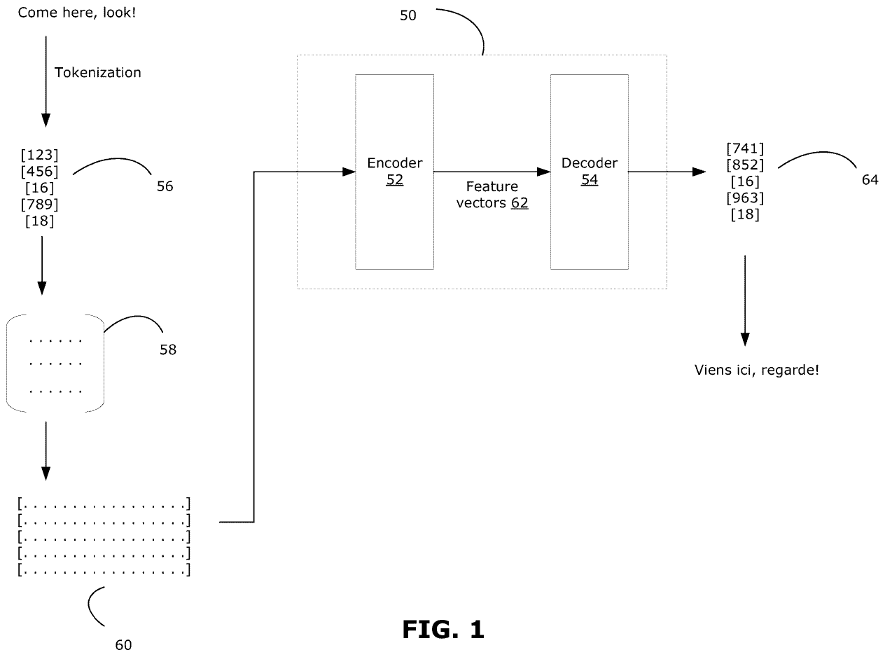

FIG. 1 is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labeled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1, a short sequence of tokens 56 corresponding to the text sequence “Come here, look!” is illustrated as input to the transformer 50. Tokenization of the text sequence into the tokens 56 may be performed by some preprocessing tokenization module such as, for example, a byte pair encoding tokenizer (the “pre” referring to the tokenization occurring prior to the processing of the tokenized input by the LLM), which is not shown in FIG. 1 for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space (or embedding space) may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

Although described above in the context of language tokens, embeddings and feature vectors are also commonly used to encode information about objects and their relationships with each other. For example, embeddings and feature vectors are frequently used in computer vision applications for object detection and semantic understanding. Embeddings that represent objects may be found in an embedding space, where the similarity and relationship of two objects (e.g., similarity between a cat and a lion) may be represented by the distance between the two corresponding embeddings in the embedding space.

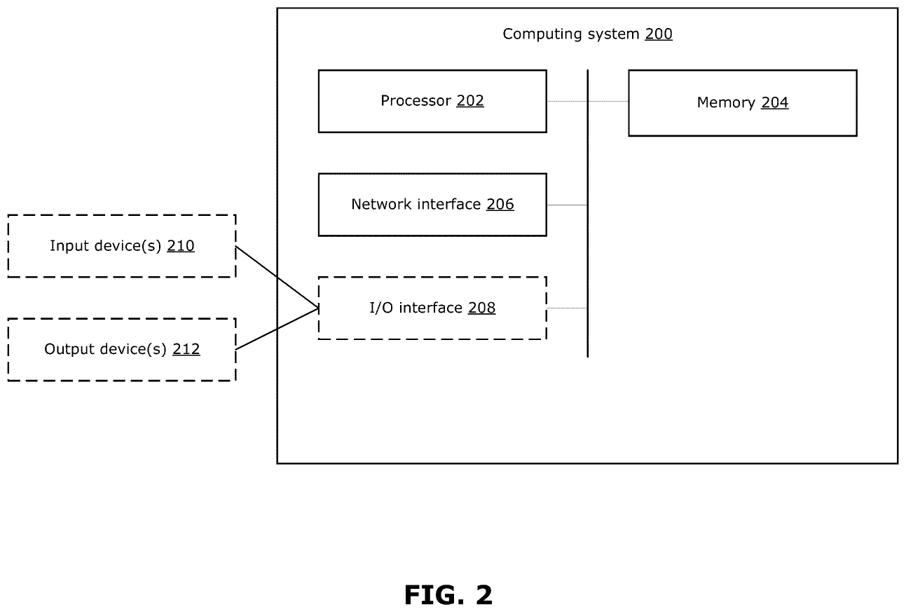

FIG. 2 illustrates an example computing system 200, which may be used to implement examples of the present disclosure. For example, the computing system 200 may be used to train a ML model for predicting future token sets at various time horizons in the future. Additionally or alternatively, the computing system 200 may be used to predict probabilities of target events occurring in various future time intervals, using the trained model, based on a historical event sequence, as disclosed herein.

The example computing system 200 includes at least one processing unit and at least one physical memory 204. The processing unit may be a hardware processor 202 (simply referred to as processor 202). The processor 202 may be, for example, a central processing unit (CPU), a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). A network interface may enable the computing system 200 to carry out communications (e.g., wireless communications) with systems external to the computing system 200, such as a foundation model residing on a remote system.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

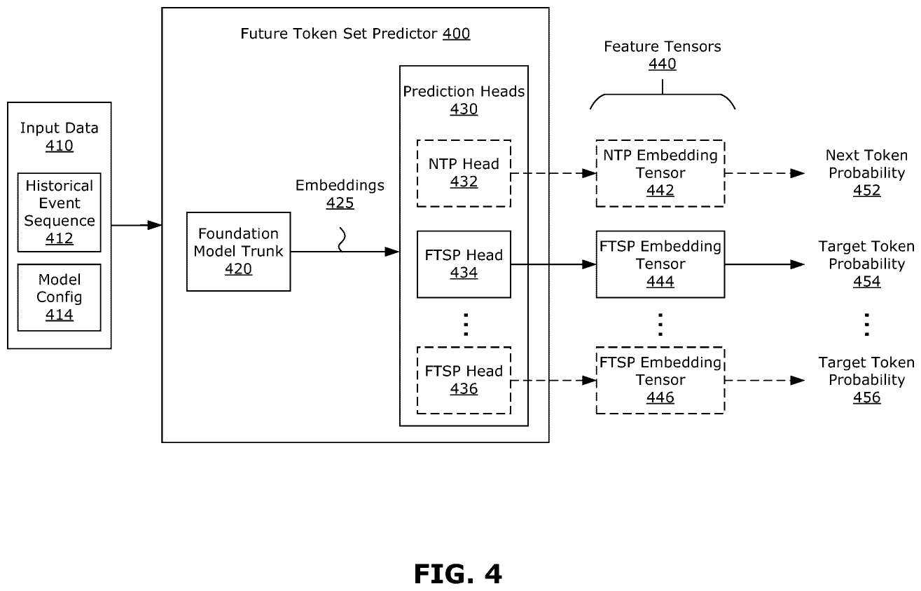

In the example of FIG. 2, the computing system 200 may store in the memory 204 computer-executable instructions, which may be executed by a processing unit such as the processor 202, to implement one or more embodiments disclosed herein. For example, the memory 204 may store instructions for implementing a future token set predictor 400, described with respect to FIG. 4 below. In some examples, the computing system 200 may be a server of an online platform that provides the future token set predictor 400 as a web-based or cloud-based service that may be accessible by a user device (e.g., via communications over a wireless network). Other such variations may be possible without departing from the subject matter of the present application.

As will be discussed further below, the present disclosure describes an example future token set predictor, for example, for predicting future token sets that are associated with various future time horizons.

In the present disclosure, a “horizon”, a “future horizon” or a “FTSP horizon” can mean: an interval occurring in the future, (e.g., relative to a current time, step or token etc.), where the interval is bounded by a distinct start and end. In examples, the horizon may be a time horizon defined by a duration D, for example, relative to the current point in time, or relative to another point in time, where D is any float. For example, a time horizon of 7 days (or a duration of 7 days) may represent a time period starting at the current point in time and ending after a duration of 7 days has lapsed. In other examples, the horizon may be a time horizon defined by a distinct start and end point, for example, where the start does not represent the current time, but rather the start represents a future point in time. For example, the time horizon may have a start corresponding to 8 days from the current point in time and an end corresponding to 14 days from the current point in time, such that the time horizon spans a duration of 7 days, but is bounded by both a start and an end that are in the future (e.g., relative to a current point in time). In examples, a time horizon defined by a start having a value of zero may be equivalent to a time horizon starting at a current point in time and spanning a duration as indicated by the specified end point. In other examples, instead of time (e.g., days), the horizon may represent an interval of steps or tokens, and the duration D may represent an interval of D steps or D tokens, relative to a starting point (e.g., a current step or a current token, or a future step or a future token), among other possibilities.

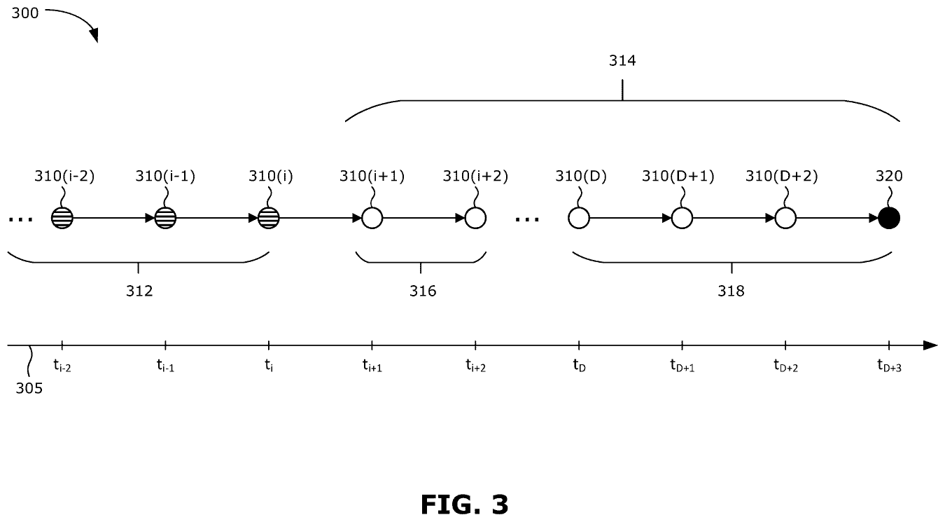

FIG. 3 shows a simplified schematic diagram of an example event sequence 300, in accordance with examples of the present disclosure. In examples, the event sequence 300 may represent a sequence of events 310 (e.g., denoted as nodes along a linear path) leading up to a target event 320. In examples, the events 310 may correspond to a software application or platform, or may be performed by a user, among other possibilities. In exemplary embodiments, the event sequence 300 may represent a sequence of events 310 associated with a software platform leading up to a target event 320 representing a fraud event, such as where a user is defrauded in some manner, among other possibilities. In exemplary embodiments, the event sequence 300 may represent a sequence of events 310 associated with a software application leading up to a target event 320 representing a software system crash event, or the event sequence 300 may represent a sequence of events 310 associated with operation of mechanical equipment leading up to a target event 320 representing an equipment failure event, among other possibilities. Although the event sequence 300 is shown in an example configuration, it should be understood that the event sequence 300 is exemplary only and that this example is not intended to be limiting.

In examples, the event sequence 300 is shown having a plurality of observed or historical events 312 and a plurality of predicted events 314, for example, with respect to a current time tᵢ. For example, historical events 312 may include a current event 310(i) that is observed corresponding to the current time tᵢ, and/or other events that have occurred prior to tᵢ (e.g., 310(i−1), 310(i−2) occurring at times tᵢ₋₁ and tᵢ₋₂, respectively). Historical events 312 may be understood to represent an event sequence of currently or previously observed events, for example, including a current time and extending for any duration into the past. In examples, predicted events 314 may include predicted next events 316 (e.g., an event 310(i+1) that is predicted for a next token, for example, occurring at time tᵢ₊₁ and/or an event 310(i+2) representing a near next token, for example, occurring at time tᵢ₊₂, among other possibilities) and predicted future events 318 (e.g., events that are predicted to occur further in the future than simply a next token or a near next token), for example, extending up to and/or including the target event 320. In examples, predicted future events 318 may include events 310(D), 310(D+1), 310(D+2) etc., for example, occurring at or after a time to, where D represents a specific future time horizon (such as 15 days, 30 days etc.), among other possibilities.

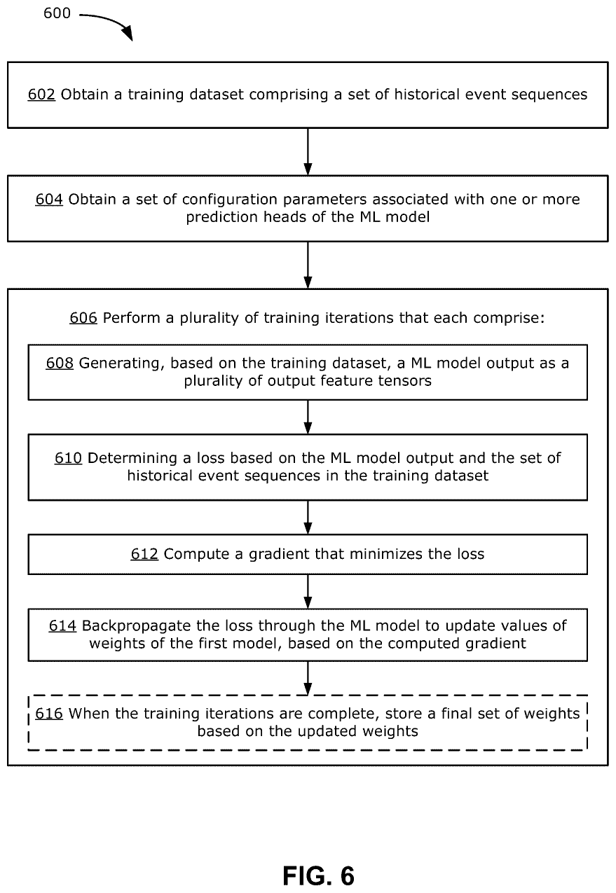

FIG. 4 shows a simplified block diagram of an example architecture for a future token set predictor 400, in accordance with examples of the present disclosure. The future token set predictor 400 may be a software that is implemented in the computing system 200 of FIG. 2, in which the processor 202 is configured to execute instructions of the future token set predictor 400 stored in the memory 204. The future token set predictor 400 includes a foundation model (e.g., foundation model trunk 420) and one or more prediction heads 430 for generating one or more feature tensors 440. It should be understood that the blocks 420 and 430 are exemplary and not intended to be limiting. For example, the future token set predictor 400 may include a greater or fewer number of blocks than shown. As well, operations described as being performed by a particular block may be additionally or alternatively performed by another subsystem. The future token set predictor 400 may be trained, for example, using the method described with respect to FIG. 6 below. The future token set predictor 400 may receive input data 410 and may generate one or more model outputs, for example, for predicting a probability of a target event 320 occurring in a pre-determined future time horizon, among other possibilities.

In examples, the input data 410 may be received by the future token set predictor 400 and may include a historical event sequence 412 and model configuration information (e.g., model config 414), among other possibilities. In examples, the historical event sequence 412 may be obtained from a data catalog of historical event sequences, for example, associated with a particular user or use case. In some examples, the historical event sequence 412 may be a subset of the data catalog of historical event sequences, for example, spanning a pre-determined duration (e.g., 1 month, 3 months, 6 months, etc.), among other possibilities. In examples, the historical event sequence 412 may be associated with a particular user, among other possibilities. In examples, the user may have a user ID or may be associated with a user account or an electronic device, for example, where information corresponding to past event sequences associated with the user, the account or the electronic device (e.g., performed by the user, or performed by a software of the electronic device, among other possibilities) may be stored. In examples, the computing system 200 may be instrumented with software necessary to monitor and capture events associated with the user, the account or the electronic device, among other possibilities. In an exemplary embodiment, a user may be interacting with a web-based application, such as a content management platform for a website, among other possibilities, and the computing system 200 may be configured to capture events as user actions, such as the creation of a new webpage, edits to the webpage content, permissions granted to view the webpage etc., or as system actions (e.g., back-end actions performed by the computing system 200), among other possibilities. In examples, the historical event sequence 412 may represent tokenized data, for example, the sequence of events may be converted into tokens representing a time series of events.

In examples, the model config 414 may be provided to the future token set predictor 400, for example, for indicating values of required model parameters for executing the future token set predictor 400, such as with respect to the desired time horizons or the desired target events, among other possibilities. In examples, the model config 414 may be associated with a configuration file, or specified in a Regex, among other possibilities.

In examples, the historical event sequence 412 and the model config 414 may be received by the future token set predictor 400, which includes a shared foundation model trunk 420 that processes the input and generates hidden representations, and a plurality of independent prediction heads 430, for example, acting as a final layer of the model, for independently predicting the model outputs. In examples, the foundation model trunk 420 may represent a generative model (such as a transformer-based language model, among other possibilities) that has been pre-trained using FTSP as an additional pretraining objective, for example, as described below with reference to FIG. 6. In examples, for each token in the historical event sequence 412, the future token set predictor 400 predicts a next token P(token| prefix) in an event sequence and a probability of a token occurring in the each specified time horizon, for example, for a duration D spanning the next D days or for a duration D=(start, end), (P_{horizon=D}(token|prefix)). For example, top layer embedding vectors for each token may be projected to a “pseudo-sequence” for predicting a set of next tokens (e.g., the next N tokens) forward from that position, for example, using cross-attention.

In examples, the foundation model trunk 420 may output a sequence of embeddings 425. In this way, sequence embeddings 425 aim to capture as much information about an input sequence as possible, in a single embedding. In examples, the embeddings 425 may be passed through each of the plurality of prediction heads 430 for transforming the embeddings 425 into respective feature tensors 440, for example, having dimensions of B×T×V, where B corresponds to batch size (e.g., number of tokens), T corresponds to the number of time steps in the event sequence and V corresponds to the vocabulary size.

In examples, the foundation model trunk 420 may represent a generative model, for example, including a transformer architecture, among other possibilities. Another example architecture for a generative recommender is the Hierarchical Sequential Transduction Units (HSTU) architecture, although using other architectures is also contemplated. An example sequential generative recommender that includes Hierarchical Sequential Transduction Units for outputting sequential recommendation tasks is described in: Zhai, Jiaqi, et al., “Actions speak louder than words: Trillion-parameter sequential transducers for generative recommendations”, arXiv preprint arXiv:2402.17152 (2024), the entirety of which is hereby incorporated by reference.

In examples, each of the independent prediction heads 430 may represent one or more FTSP heads (e.g., FTSP head 434, FTSP head 436) for predicting a likelihood of a target token occurring over a specified time horizon, or optionally, an NTP language model (LM) head (e.g., NTP head 432) for predicting a probability distribution of a next token. In examples, each of the one or more FTSP heads may be associated with a specified time horizon, for example, where the time horizon is configured with respect to a current time tᵢ. In other words, for any input token, there is a corresponding output token embedding that is fed to each of the one or more FTSP heads (e.g., FTSP head 434, FTSP head 436) and/or the NTP head 432 to predict the corresponding FTSP sets and/or the next token, respectively.

In examples, each feature tensor 440 may be processed, for example, using a logistic regression function, to obtain the respective token probabilities (e.g., target token probability 454, target token probability 456 or next token probability 452). For example, in the case of FTSP-based outputs, target token probability 454 or target token probability 456 may indicate the likelihood of the target token 320 occurring during a specified time horizon, or in the case of NTP-based outputs, next token probability 452 may indicate a likelihood of each token in the vocabulary being the next one in the sequence, among other possibilities.

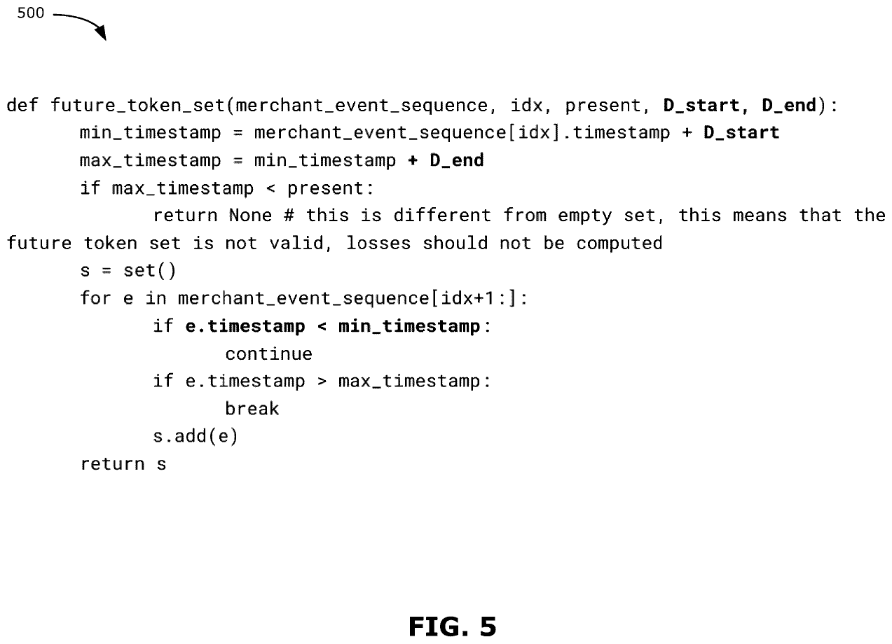

FIG. 5 shows an example algorithm 500 for computing a future token set, using the trained future token set predictor 400, in accordance with examples of the present disclosure. In examples, the time horizon is specified using a tuple D=(start, end), for example, D=(0, 30) specifies a time horizon spanning from the current point in time to 30 days in the future, where D=(30, 60) specifies a time horizon spanning from 30 days in the future to 60 days in the future. In examples, some information, such as the time horizon tuple may be obtained from the configuration 414, among other possibilities. The algorithm for constructing the future token set uses the time horizon information along with an input event sequence to predict multiple future tokens in the token set s, for example, starting from a given position in the sequence (e.g., corresponding to the start of the time horizon) until the end of the specified time horizon is reached. It should be understood that the example algorithm 500 is exemplary only and that this example is not intended to be limiting.

A method for training the future token set predictor 400 is now described with respect to FIG. 6.

FIG. 6 is a flowchart of an example method 600 for training the future token set predictor 400 for predicting a sequence of tokens over different time horizons, in accordance with examples of the present disclosure. The method 600 may be performed by the computing system 200. For example, a processing unit of a computing system (e.g., the processor 202 of the computing system 200 of FIG. 2) may execute instructions (e.g., instructions of the future token set predictor 400) to cause the computing system to carry out the example method 600. The method 600 may, for example, be implemented by an online platform or a server.

At an operation 602, a training dataset comprising a set of historical event sequences may be obtained. In examples, the set of historical event sequences may be a time series dataset, where each data sample represents an event in a corresponding event sequence. In some examples, events of interest (e.g., such as milestones or desired end states, fraud events, failure events etc.) corresponding to particular use cases (e.g., to attain a user goal or outcome, to prevent a fraud event, to prevent or mitigate a failure event etc.) may be included in the historical event sequences. In some examples, the training dataset may span a pre-determined duration (e.g., 1 month, 3 months, 6 months, etc.) or the training dataset may include an entire data catalog of historical event sequences, for example, representing user activity across multiple users or use cases, among other possibilities. In examples, data sample may include corresponding metadata, such as the user ID, timestamp, event source (e.g., application where the user action was performed), among other possibilities. In examples, the training dataset may represent tokenized data, for example, the set of historical event sequences may be converted into tokens representing a time series of events.

At an operation 604, a set of configuration parameters associated with the plurality of prediction heads 430 may be obtained. For example, the configuration parameters may include parameters used for configuring the training of the future token set predictor 400 and may be associated with a configuration file, or specified in a Regex, among other possibilities. In examples, the configuration parameters may indicate the FTSP time horizons (e.g., as a duration D from the current time, for example, 7 days, 30 days, 90 days, 180 days etc.) and/or the configuration parameters may include a set of weights, among other possibilities.

In examples, the set of weights may correspond to a type of prediction head, such as the NTP head 432 or the FTSP heads (e.g., FTSP heads 434, 436). In some embodiments, for example, the weights may correspond to FTSP time horizons (e.g., horizon weights), or in other embodiments, the weights may be token weights corresponding to tokens in the token vocabulary, among other possibilities. For example, for certain use cases, particular tokens associated with the vocabulary V may not need to be predicted or otherwise included in a future token set. Accordingly, each token may be associated with a respective token weight, and a value of the token weight may be set equal to zero for tokens that should not be included in any predictions. In some embodiments, for example, all token weights may be set equal to zero and only those tokens associated with target tokens may be assigned a non-zero weight. In this way, the output feature tensor dimensions may be reduced from B×T×V to B×T×K, where K represents the number of tokens in the vocabulary having non-zero weights, thereby helping to reduce computational load during FTSP processes. In contrast, for NTP processes the full vocabulary is computed.

At an operation 606, the future token set predictor 400 may be trained, using the training dataset during a supervised learning process, to minimize a loss between the model output corresponding to each prediction head, and the training data. In examples, the future token set predictor 400 may be a neural network model, and training the future token set predictor 400 comprises performing a plurality of training iterations. For each of the plurality of training iterations, the following operations 608-616 may be performed.

At an operation 608, the model output may be generated, based on the training dataset. In examples, the model output may include a plurality of output feature tensors. During training, the same forward pass of the foundation model trunk 420 is leveraged, while each of the plurality of output feature tensors corresponds to a respective prediction head of the plurality of prediction heads 430. In examples, the model output may also include an indication of whether a target event is present in the future token set. In examples, rather than employing a softmax over event logits (e.g., which may be used to convert logits into a probability distribution when there are more than two possible outcomes), logistic regression may be performed for each target event for generating a probability of the target event being present in the future token set (or not being present).

At an operation 610, a loss L may be determined based on the ML model output and the set of event historical sequences in the training dataset. For example, for every token (t) in a generated future token set, the loss L^{(t)} may be computed using equation 1:

$${L}^{( t )} = {α}_{ntp} {L}_{ntp}^{( t )} + {L}_{ftsp}^{( t )} \qquad ( 1 )$$

$$where$$

$${L}_{ntp}^{( t )}$$

is the NTP loss (e.g., predicted by the NTP head 432), αₙₜₚ is the weight applied to the NTP loss and

$${L}_{ftsp}^{( t )}$$

is the risk loss for the token. In this regard, applying a weight to the NTP loss enables the model to be trained as a combined NTP/FTSP model or as a purely FTSP model. For example, incorporating the NTP head 432 in the future token set predictor 400 may be optional, and setting the weight applied to the NTP loss to zero trains the model only based on FTSP. In some embodiments a weight may also be applied to the FTSP loss (e.g., using horizon weights described below with respect to equation 2) to enable training the model as a purely NTP model, thereby providing greater generality for the approach. In some embodiments, for example, the NTP loss may be a cross entropy loss.

In examples, for each token in the future token set, the FTSP loss may be computed using equation 2:

$${L}_{ftsp}^{( t )} = {\sum }_{horizon ∈ H} {α}_{horizon} {L}_{horizon}^{( t )} \qquad ( 2 )$$

$$where$$

$${L}_{ftsp}^{( t )}$$

represents a sum of losses over multiple time horizons H. In this way, the model can be trained to predict future token sets over different time horizons (e.g., 7 days, 30 days, 90 days etc.). For example, if the model architecture is configured to include multiple FTSP prediction heads (e.g., each associated with a particular time horizon), each feature tensor generated by the respective FTSP prediction head will be associated with a horizon loss

$${L}_{horizon}^{( t )} ,$$

Each horizon loss may also be weighted using a horizon weight α_{horizon}. In this way, losses for particular horizons may be amplified or attenuated to increase or decrease the importance attributed to each horizon (e.g., α_{7 days}=0, α_{30 days}=0.5, α_{90 days}=1) providing greater generality for the approach.

In examples, for each token in the future token set, the horizon loss

$${L}_{horizon}^{( t )}$$

may be computed using equation 3:

$${L}_{horizon}^{( t )} = {\sum }_{token , present ∈ fts ( t , horizon )} {α}_{token} {L}_{token , present}^{( t )} \qquad ( 3 )$$

$$where$$

$${L}_{horizon}^{( t )}$$

represents a sum of losses over multiple tokens or token classes that are present in the future token set (FTS) corresponding to a specified horizon, and

$${L}_{token , present}^{( t )}$$

represents a token loss for each token in the generated future token set, where each token loss may be weighted by a respective token weight αₜₒₖₑₙ for the token. In some embodiments, for example, the token losses may be cross entropy losses, among other possibilities.

In examples, for each token in the future token set, a token loss

$${L}_{token , present}^{( t )}$$

may be determined via a Negative Log Likelihood approach (or alternatively, using Binary Cross Entropy, among other possibilities). In examples, the token loss

$${L}_{token , present}^{( t )}$$

may be computed using equation 4:

$${L}_{token , present}^{( t )} = - ( present * log ( p ( token ) ) + ( 1 - present ) * log ( 1 - p ( token ) ) ) \qquad ( 4 )$$

where the term present indicates whether the token is present in the future token set (e.g., where a value of zero indicates that the token is not present in the future token set and a value of 1 indicates that the token is present the future token set), and p(token) represents a probability, assigned to the token by a corresponding FTSP head, that the token appears in the corresponding future token set for (t,horizon).

As previously described with respect to operation 604, particular tokens may not need to be predicted or otherwise included in a future token set. For example, there may be some events in an event sequence that represent action events and others that represent outcome events, where outcomes are predicted based on actions, therefore the use case may dictate that the model be trained to predict outcome events only. In another example, a vocabulary of event tokens may be large but the use case may dictate that the model be trained to only predict milestone events, among other possibilities. In this regard, some event tokens in the vocabulary V may be effectively masked (e.g., αₜₒₖₑₙ=0), providing an ability to set which tokens the model is trained to predict, and which tokens do not need to be predicted. In this way, reducing the size of the vocabulary effectively reduces the computational resources needed for model training.

At an operation 612, a gradient may be computed with an objective of minimizing the loss. At an operation 614, the loss may be backpropagated through the future token set predictor 400 to update values of weights of the future token set predictor 400, based on the computed gradient. At an operation 616, when the training iterations are complete, a final set of model weights may be stored based on the updated weights.

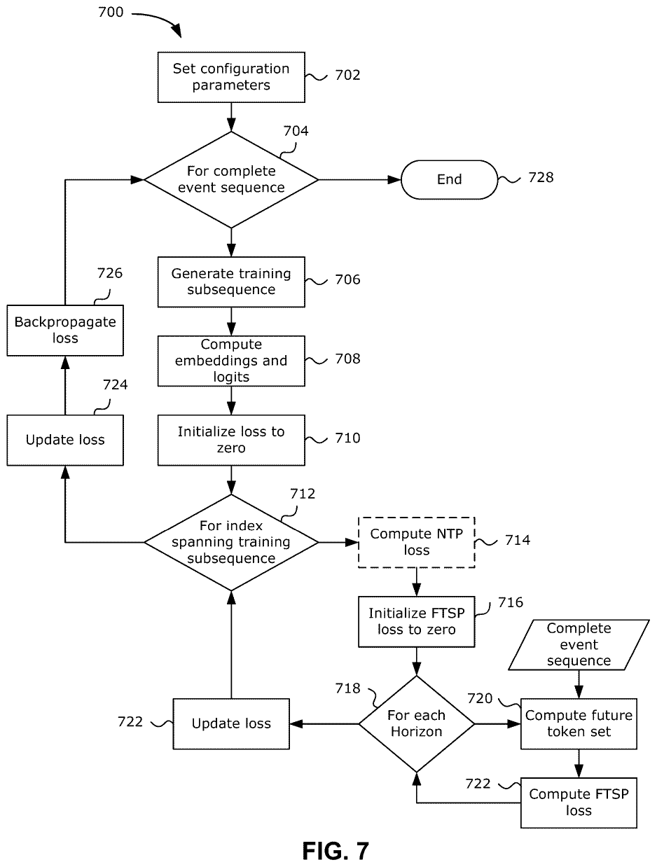

FIG. 7 shows an example method 700 for training the future token set predictor 400, in accordance with examples of the present disclosure. At step 702, configuration parameters may be set. For example, the horizons are specified using a list of tuples (weight, D_start, D_end) where weights associated with each prediction head 430 (e.g., weight_ntp, weight_ftsp time) and horizon tuples may be obtained from a configuration file, among other possibilities.

At step 704, the method for training the future token set predictor 400 uses the weights and time horizon information along with a training dataset (e.g., a complete event sequence to train the future token set predictor 400 to predict corresponding future token sets for each horizon and/or next tokens.

At step 706, a training subsequence may be generated. For example, the training subsequence may represent an event sequence that is extracted from the complete event sequence, for example, based on an offset value and a maximum sequence length, among other possibilities.

At step 708, a forward pass of the foundation model trunk 420 may generate a set of embeddings. In examples, logits may be computed for each of the prediction heads 430 of the future token set predictor 400. For example, logits associated with the NTP head 432 and each of the FTSP heads (e.g., FTSP head 434, 436) may be generated using a dot product operation on embedding vectors for the NTP head 432 and each of the FTSP heads, among other possibilities. In examples, at step 710 a loss term may also be initialized to zero.

At step 712, the method for training the future token set predictor 400 may iterate over an index spanning a length of the training subsequence to update the loss term with respect to an NTP loss term and a FTSP loss term. For example, at step 714, the NTP loss term may optionally be computed as described with respect to FIG. 6 (e.g., if the NTP weight is not set to zero) and at step 716 the FTSP loss term may be initialized to zero.

At step 718, the method for training the future token set predictor 400 may iterate over each horizon to update the FTSP loss term. For example, at step 720, a future token set may be computed for each horizon and at step 722 the FTSP loss term may be computed as described with respect to FIG. 6. As shown in the example method 700, future token sets are computed on complete event sequences. Furthermore, it may be possible to configure the training such that future token sets are set to “None”, in which case FTSP loss terms may not be computed and incorporated into the overall loss calculation.

At step 722, the loss term may be updated to reflect the NTP loss and FTSP loss terms. For example, for each iteration of the method at step 718 corresponding to index spanning the training subsequence, a sum of the NTP loss term and the FTSP loss term may be added to the overall loss term (where the NTP loss term and the FTSP loss term may be weighted as described with respect to FIG. 6, among other possibilities).

At step 724 the loss term may be updated to reflect the number of events in the training subsequence, for example, to average the loss having been accumulated for each iteration of the method at step 718. For example, the accumulated loss term may be divided by the number of events in the training subsequence, among other possibilities. At step 726, the updated loss term may be backpropagated through the future token set predictor 400, for example, to update weights of the future token set predictor 400.

At step 728, upon meeting pre-determined training criteria, the training may end. It should be understood that the example method 700 is exemplary only and that this example is not intended to be limiting.

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
training a machine learning (ML) model for predicting future token sets over different future horizons by:
obtaining a training dataset comprising a set of historical event sequences;
obtaining a set of configuration parameters associated with a plurality of prediction head layers of the ML model, each of the prediction head layers corresponding to a respective future horizon; and
performing a plurality of training iterations for training the ML model, wherein each training iteration comprises:
generating, based on the training dataset, a ML model output including a plurality of output feature tensors;
determining a loss based on the plurality of output feature tensors and the set of historical event sequences;
computing a gradient that minimizes the loss; and
backpropagating, based on the computed gradient, the loss through the ML model to update values of weights of the ML model.

2. Obtaining a set of trained model parameters, the model parameters having been generated according to the method of claim 1.

3. The method of claim 1, wherein the different future horizons represent different future time intervals, each future time interval having a start time and an end time in reference to a current time.

4. The method of claim 1, wherein the loss is a cross-entropy loss.

5. The method of claim 1, wherein the loss represents a sum of a next token prediction (NTP) loss and a future token set prediction (FTSP) loss.

6. The method of claim 1, wherein determining the loss comprises:
determining one or more horizon losses, wherein each horizon loss corresponds to a respective future horizon, and wherein each future horizon is associated with a respective horizon weight value; and
determining a FTSP loss as a sum of the one or more horizon losses.

7. The method of claim 6, wherein determining the FTSP loss comprises:
determining a horizon loss as a sum of multiple token losses associated with multiple tokens in a future token prediction set, wherein each token is associated with a respective token weight value.

8. The method of claim 7, wherein dimensions of the output feature tensors are determined by dimensions of output sequence embeddings and a token vocabulary, the method further comprising:
reducing the dimension of the token vocabulary by setting one or more token weight values equal to zero.

9. The method of claim 1, wherein the ML model is a foundation model.

10. The method of claim 2, further comprising:
implementing the set of trained model parameters in an inference step to:
generate a future token set corresponding to a respective future horizon; and
predict whether an event of interest occurs in the future token set.

11. A computer system comprising:
a processing unit configured to execute computer-readable instructions to cause the system to:
train a machine learning (ML) model for predicting future token sets over different future horizons by:
obtaining a training dataset comprising a set of historical event sequences;
obtaining a set of configuration parameters associated with a plurality of prediction head layers of the ML model, each of the prediction head layers corresponding to a respective future horizon; and
performing a plurality of training iterations for training the ML model, wherein each training iteration comprises:
generating, based on the training dataset, a ML model output including a plurality of output feature tensors;
determining a loss based on the plurality of output feature tensors and the set of historical event sequences;
computing a gradient that minimizes the loss; and
backpropagating, based on the computed gradient, the loss through the ML model to update values of weights of the ML model.

12. The system of claim 11, wherein the different future horizons represent different future time intervals, each future time interval having a start time and an end time in reference to a current time.

13. The system of claim 11, wherein the loss is a cross-entropy loss.

14. The system of claim 11, wherein the loss represents a sum of a next token prediction (NTP) loss and a future token set prediction (FTSP) loss.

15. The system of claim 11, wherein in determining the loss, the processing unit is further configured to execute computer-readable instructions to cause the computer system to:
determine one or more horizon losses, wherein each horizon loss corresponds to a respective future horizon, and wherein each future horizon is associated with a respective horizon weight value; and
determine a FTSP loss as a sum of the one or more horizon losses.

16. The system of claim 15, wherein in determining the FTSP loss, the processing unit is further configured to execute computer-readable instructions to cause the computer system to:
determine a horizon loss as a sum of multiple token losses associated with multiple tokens in a future token prediction set, wherein each token is associated with a respective token weight value.

17. The system of claim 16, wherein dimensions of the output feature tensors are determined by dimensions of output sequence embeddings and a token vocabulary, and the processing unit is further configured to execute computer-readable instructions to cause the computer system to:
reduce the dimension of the token vocabulary by setting one or more token weight values equal to zero.

18. The system of claim 11, wherein the ML model is a foundation model.

19. The system of claim 11, wherein the processing unit is further configured to execute computer-readable instructions to cause the computer system to:
obtain a set of trained model parameters corresponding to the trained ML model; and
implement the set of trained model parameters in an inference step to:
generate a future token set corresponding to a respective time horizon; and
predict whether an event of interest occurs in the future token set.

20. A non-transitory computer-readable medium storing instructions that, when executed by a processing unit of a computing system, cause the computing system to:
train a machine learning (ML) model for predicting future token sets over different future horizons by:
obtaining a training dataset comprising a set of historical event sequences;
obtaining a set of configuration parameters associated with a plurality of prediction head layers of the ML model, each of the prediction head layers corresponding to a respective future horizon; and
performing a plurality of training iterations for training the ML model, wherein each training iteration comprises:
generating, based on the training dataset, a ML model output including a plurality of output feature tensors;
determining a loss based on the plurality of output feature tensors and the set of historical event sequences;
computing a gradient that minimizes the loss; and
backpropagating, based on the computed gradient, the loss through the ML model to update values of weights of the ML model.
